(19) United States
(12) Patent Application Publication
(10) Pub. No.: US 2024/0261171 A1
(43) Pub. Date: Aug. 8, 2024

(54) Walking Frame for Adults

(71) Applicant: ES Healthcare AS, Trondheim (NO)

(72) Inventor: Else Skjeldam, Trondheim (NO)

(21) Appl. No.: 18/567,816

(22) PCT Filed: Jun. 7, 2022
(86) PCT No.: PCT/NO2022/050129

§ 371 Date: Dec. 7, 2023

(30) Foreign Application Priority Data
Jun. 8, 2021 (NO) 20210721

(51) Int. Cl. A61H 3/04; A61G 5/14; A61H 3/00

(52) U.S. Cl. CPC A61H 3/04; A61G 5/14; A61H 2003/006; A61H 2003/046; A61H 2201/0157; A61H 2201/0192; A61H 2201/1635

(57) ABSTRACT

Walking frame comprising front and rear wheels, an upper frame part that together with a hinged gate forms a closed hoop and wheel-holding, front and rear frame parts, said wheel-holding frame parts being directly or indirectly attached to or integrated with the upper frame part. The hinged gate is arranged at a rear end of the upper frame part. The rear wheel-holding frame parts extend in the direction of the rear wheels further back than the rear end of the upper frame part in a lower area that, in the vertical direction, is located less than 35 cm above the lower surface of the wheels of the wheels, in a horizontal extension of at least 10 cm behind a plumb line drawn down from the rear end of the upper frame part.

### BACKGROUND

The disclosed embodiments relate to a walking frame.

Many elderly people, living at home or in institutions, experience problems with balance, often in combination with failing muscle power. This often leads to falls, which in turn can lead to injuries and reduced quality of life, often fractures that involve great pain and a long convalescence.

People with problems as mentioned above often need help on a daily basis with such trivial things as getting out of bed safely or sitting down on a toilet seat. In institutions, the assistance of two people is often required to help with such trivial actions.

For support, a number of different types of walkers or walking frames have been developed, but so far none have provided a fully satisfactory solution to the above-mentioned problems, to reduce the risk of falling accidents that is still present when using traditional walkers and other known aids as well as to relieve healthcare personnel and others with support functions when it comes to helping people with the aforementioned type of problems in their daily tasks.

US 2005/0183759 A1 describes a closed walking frame, that is a walking frame where the user is completely surrounded by the frame, which includes a gate through which the user can pass and which closes behind him or her. It prevents the user from falling unless the entire walking frame tips over. Furthermore, the walking frame according to US 2005/0183759 comprises a harness that can be fastened around the abdomen of the user so that the person can stay upright even if the strength in the legs is not sufficient for supporting the entire weight of the person.

WO 2010/027313 A1 Describes an open walking frame, that is to say that the user is not surrounded by the walking frame, but has it in front of him or her and partly on his/her sides. It includes a harness that can prevent the user from falling. Furthermore, it has the wheels attached to a horizontal U-bow which is open at the rear of the frame and which allows passage under a chair, which can be convenient when the user is to sit down.

Other known walking frames are described, among others, in US 2008 176720 A1 and GB 2 409 178 A.

### SUMMARY

Provided herein is a device which significantly reduces or eliminates the risk of falling accidents, and which facilitates the need for assistance for people with movement problems as mentioned above.

In particular, a device is provided that significantly reduces the risk of falling accidents for people with poor balance and/or muscle strength and which is also suitable for use by people who still have sufficient strength to walk on their own, albeit with reduced balance ability.

Furthermore, the device makes it easy and safe for a user to get from a standing to a sitting position and vice versa.

The herein disclosed walking frame comprises a structure that surrounds the user on all sides so that falling sideways or backwards is prevented when the pivoting part of the upper frame part is closed behind the user. Basically, the person can sink down within the limitation set by the walking frame. In such cases, the risk of injury is significantly reduced, partly because the space limited by the frame is so small that it is impossible for the head to come into contact with the floor. With the help of the disclosed embodiments, the user gets the opportunity to manage himself or herself to a greater extent without the constant help of careers or others.

For reasons of stability, among other things, the upper part of the frame is relatively narrow, while the lower part of the frame is wider and with the wheels placed far out, but not further out or wider than allowing the walking frame to pass through standard doorways.

By “frame parts” as used in this document is understood, unless otherwise stated, structural frame parts, i.e., parts that give the walking frame its strength and integrity, i.e., all load-bearing and supporting parts. Padding or accessories whose purpose is to provide comfort, but not strength, are not referred to as frame parts.

In the following, when direction is referred to as up and down, upper and lower as well as vertical and horizontal, this is in relation to an orientation of the walking frame in a position of use, i.e., with the wheels down on a flat, horizontal floor.

What most distinctly characterizes the walking frame disclosed herein is the design of the rear, lower parts of the walking frame, specifically the parts to which the rear wheels are attached, as well as the resulting position of the rear wheels relative to the rest of the walking frame.

Typically, the rear wheel-holding frame members extend rearward towards the wheels at a height low enough to pass under furniture such as beds, chairs and sofas. The vertical level of the parts of the frame, which extend to the rear is typically less than 35 cm, more preferably less than 25 cm and most preferably less than 15 cm above floor level. The horizontal extent of this low frame part, which is located behind a plumb line drawn from the rear end of the upper frame part, is typically at least 10 cm counted from the wheel centre, more preferably at least 20 cm and most preferably at least 30 cm.

The characteristic design of the rear, lower frame parts, to which the rear wheels are attached, allows the rear wheels to be located significantly further back than the rear part of the upper frame part, while the rear, lower frame parts to which the rear wheels are attached, extend backwards in a low position allowing the wheels to move under a bed, a chair or a sofa without any part of the frame butting against a front edge of any of the aforementioned furniture. An increased stability of the walking frame in the backward direction is thereby achieved, and particularly in situations where the user has to sit down on a bed, in a chair or a sofa, and where the user with a normal walking frame might easily press down with great force approximately directly above the rear wheels. With the disclosed walking frame, the downward pressure when the user sits down and/or stands up will always be well in front of the rear wheels and always well within the support surface defined by the four wheels together.

### BRIEF DESCRIPTION OF THE DRAWINGS

In the following, the invention will be described in more detail with reference to the accompanying figures where

FIG. 1 schematically in perspective an embodiment of an embodiment of the walking frame;

FIG. 2A is a schematic view of the walking frame seen from the front;

FIG. 2B is a schematic side view of the walking frame;

FIG. 2C is a schematic side view of another embodiment of the walking frame differing from the embodiment shown in FIG. 2B;

FIG. 3 is a schematic side view of an embodiment of the walking frame together with a user.

### DETAILED DESCRIPTION

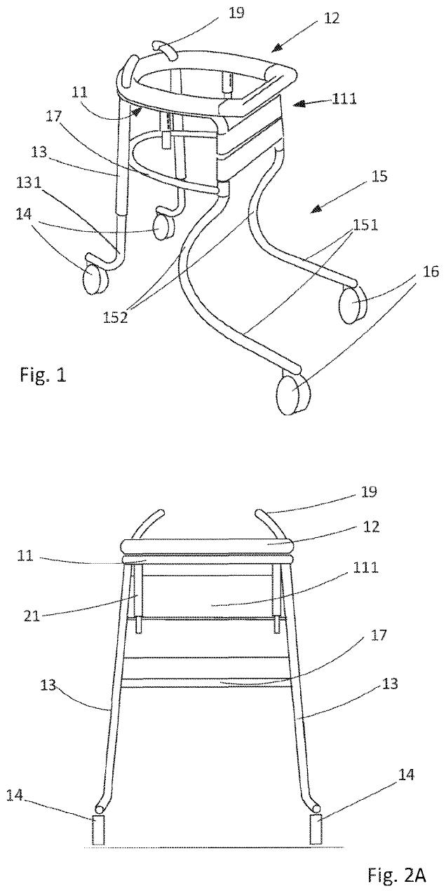

FIG. 1 shows in perspective an embodiment of the walking frame with an upper frame part 11, which forms a closed hoop that is closed at its rear with a gate 111 that in the closed position thereby closes the upper frame part. The gate 111 can be opened and closed as needed, when a user is to pass into or out of the walking frame.

The frame parts include two front wheel-holding frame parts 13 that extend from the upper frame part down to each of the front wheels 14 and two rear wheel-holding frame parts 15 that extend down to each of the rear wheels 16. An intermediate frame part 17 can advantageously tie together the front 13 and rear 15 wheel-holding frame parts at a distance below the upper frame part 11 to increase the stability of the walking frame.

As shown in FIG. 1, the lower part 131 of the front wheel-holding frame parts 13 down towards the front wheels 14 can be swung forwards to improve the stability of the frame in the forward direction.

The most distinctive feature of the walking frame, however, is the rear wheel-holding frame parts 15 that, in the direction of the rear wheels 16, in a lower area 151, are drawn backwards and significantly further back than the rear edge of the upper frame part 11 that in practice is constituted by the gate 111.

This means that the rear wheels and all or most of the lower area 151 of the rear wheel-holding frame parts can pass under a bed edge, an armchair, a sofa or the like. The extended distance between the front wheel 14 and the rear wheel 16 and not least the fact that the rear wheels will be well behind the user when the person is to move from a standing to a sitting position and vice versa, contributes greatly to improving the stability of the walking frame during these manoeuvres.

FIG. 1 further shows that the rear, wheel-holding frame parts 15 in an area below the gate 111, but above the lower area 151, are curved forwards in an intermediate area 152. This represents a preferred, not mandatory shape of the rear wheel-holding frame parts 15.

In connection with the upper frame part 11, a replaceable padding 12 or the like, suitable for supporting the forearms, as well as handles 19 at or near the front end of the upper frame part, will typically be mounted.

Advantageously, the disclosed walking frame can be height adjustable, in that the front 13 and rear wheel-holding frame parts 15 are extendable, for example as shown in FIG. 1, where a lower section 131 of the front wheel-holding frame part 13 has a smaller diameter than the upper section and is pushed into this, and to varying degrees can be pulled out of the upper part to adjust the height of the walking frame. The same applies to the section of the rear wheel-holding frame parts, at the point where the intermediate frame part is attached.

The intermediate frame part 17 can optionally be equipped with exchangeable weight elements that, if such are used, help to lower the centre of gravity of the walking frame and to give it greater inertia, so that movements in the event of a sudden impact—intentional or unintentional—become slower. This can be an advantage to use for particularly tall or heavy users or for users who have problems controlling muscle movements, so that the consequences of jerks are reduced.

The attachment of both the front wheels 14 and the rear wheels 16 to the wheel-holding frame parts shown in FIG. 1 enables both the rear wheels and the front wheels to be turned in the same way as the wheels on an office chair. However, swivelling rear wheels it is not a mandatory feature.

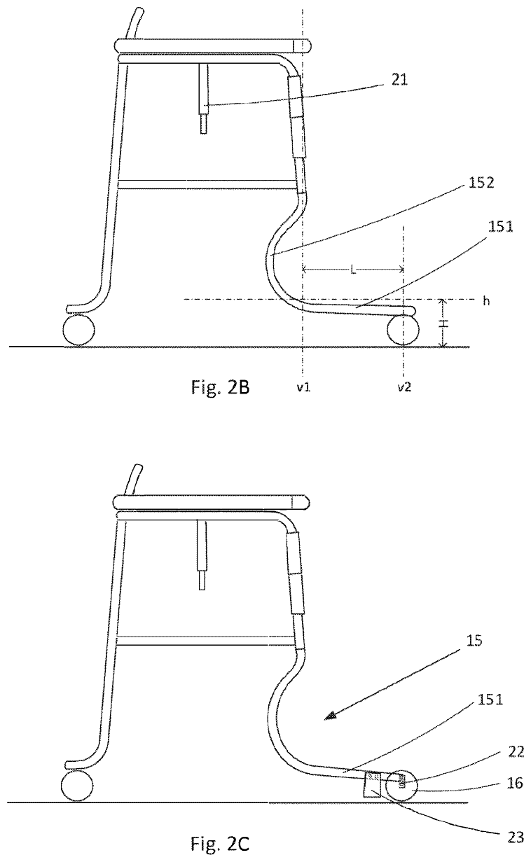

FIG. 2A shows a walking frame in a diagram in a front view. With upper frame part 11, gate 111 attached between non-visible rear wheel-holding frame parts, front wheel-holding frame parts 13 and front wheel 14. The rear wheel-holding frame parts are hidden behind the front wheel-holding frame parts. FIG. 2A also shows harness attachments 21. The harness can, for example, be used for users with reduced leg strength and/or reduced balance ability.

FIG. 2B shows the walking frame of FIG. 2A in a side view. A first vertical dotted line v1 is drawn down from the rear end of the upper frame part 11 and a second vertical dotted line v2 is shown through the wheel axis of the rear wheel 16. The distance between these is marked with an arrow marked “L”. The distance L must be at least 10 cm, more preferably at least 20 cm and most preferably at least 30 cm.

Furthermore, a horizontal dashed line h has been drawn at a given height “H” above the floor. The lower frame part 151 must stay within the vertical area limited by the floor and the height H, which is a maximum of 35 cm, more preferably a maximum of 25 cm and most preferably a maximum of 15 cm.

In the embodiment shown in FIG. 2B, the inclination angle of the frame part 151 in the retracted area is very small, it is approximately horizontal. However, the inclination angle can be greater as long as an area L of at least 10 cm is below the vertical maximum level mentioned in the paragraph above. It is preferred that the inclination angle of the rear, wheel-holding frame parts in the area 151 is small and preferably less than 25 degrees, more preferably less than 15 degrees and most preferably less than 5 degrees in relation to the horizontal plane. The inclination angle need not be constant throughout the area; it can, for example, be 5 degrees up to the rear wheels and gradually increase to 15 degrees at the point that crosses the plumb line v1 shown in FIG. 2B.

If, for example, the rear wheels are 30 cm behind the mentioned plumb line and the average inclination of the rear wheel-holding frame parts 15 in the area 151 is 10 degrees, the height of the rear wheel-holding frame parts will rise only approx. 5 cm from the rear wheels to the point where they cross the plumb line v1.

FIG. 2B also shows that the rear wheel-holding frame parts 15 in an intermediate area 152 curve forwards in relation to the plumb line from the rear end of the upper frame part 11. It is not a prerequisite for the present invention that this curvature is present, but it is appropriate from a practical point of view and also aesthetically appealing.

FIG. 2C shows an alternative design to the design shown in FIG. 2B regarding the connection of the rear wheels to the rear, wheel-holding frame parts 15. Here, the rear wheel-holding frame parts are connected to the rear wheels 16 via a through wheel axle instead of from above, which assumes that the rear wheels are attached on a non-rotating axis. This may be desirable on the basis that it improves the directional stability of the walking frame that only two wheels are pivotable, albeit somewhat at the expense of its maneuverability. Furthermore, a spring device 22 is connected between each respective rear wheel-holding frame part 15 and each rear wheel 16, so that a springy effect occurs if the rear part of the walking frame is pressed down with force.

Furthermore, a brake pad 23 is shown in front of the rear wheel 16, the brake pad 23 being positioned and dimensioned in such a way that with a given downward force on the rear part of the walking frame, the brake pad will come into contact with the ground and brake any movement of the walking frame. If the walking frame is at rest and a user is about to sit down and at the same time presses down on the walking frame at its rear edge, the brake pad will prevent the walking frame from moving forward or backward even if there is a certain force component from the user in the forward or backward direction in addition to the downwards force. It should be understood that a similar effect can be achieved with a brake pad that, when the walking frame is pressed down, comes into contact with part of the wheel and thereby slows the wheel's rotation.

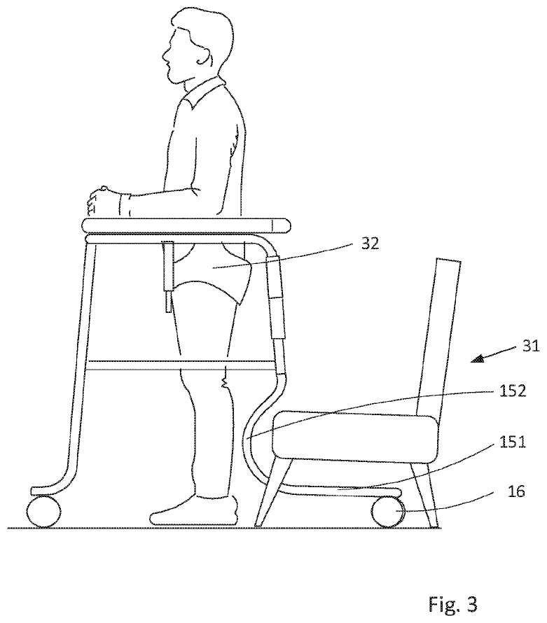

FIG. 3 shows the walking frame of FIG. 2B in a somewhat reduced image size, with a user inside the walking frame. The walking frame is backed up to a couch 31 with the rear wheels and lower area 151 of rear wheel-holding frame parts 15 under the couch. The practical consequence of the intermediate area 152 of the rear wheel-holding frame parts 15 curving forwards is also illustrated by FIG. 3. It allows the walking frame to come extra close to the sofa so that it becomes even easier for the user to sit down on the sofa.

The user in FIG. 3 is also shown with harness 32, which is an option with the present walking frame. When the harness is securely attached to the user and further attached to the harness attachment 41, the user will not be able to fall or sink into the walking frame even if the strength in the legs fails completely and not even in the event of loss of consciousness, since the entire lower part of the body is held up by the harness 40, the harness attachment 41 and the walking frame as such.

A harness as mentioned above can possibly also be used in a half-sitting position where the user can pull himself forward with the help of his/her feet without carrying his entire weight with his legs and feet. For such use, the harness may possibly include a relatively stiff seat surface that gives the user better support and is thereby more comfortable to use than a harness made solely by straps.

The walking frame disclosed herein can also be equipped with other equipment known from walking frames, such as manual brakes, preferably fixable brakes on two or more wheels so that the wheels are blocked against rotation until the brakes are released. However, such functionality is not further described or shown, as it is traditional as such and not peculiar to the disclosed embodiments of the walking frame.

The front wheels 14 on the walking frame must sit on a rotatable axis, while the rear wheels 16 can optionally be attached to a rotatable axis or an axis with a fixed orientation as provided for in the variant shown in FIG. 2C.

The wheels can optionally be supplied with adjustable friction, so that, for example, for heavier users it can be adjusted so some extra force is required to push it. This can be used as an element in training, but also as a safety element, making it less easy to move quickly.

Other electrical or electronic aids, such as alarms, can also be included, but are not the subject of the present invention and therefore not discussed in more detail here.

In addition to the paddings 12 shown in FIG. 1, designed to support the forearms of the user, cushions being attached to height-adjustable struts attached to the upper frame part 11 may also be included, designed to support under the armpits of the user.

It is convenient that the lower frame parts are sufficiently wide to provide the desired stability without being too wide to pass through doors, while the upper frame part 11 can advantageously be relatively narrow, so that the open area limited by the upper frame part, is not significantly larger than what is required for a person to be able to stand within the frame.

1-14. (canceled)

15. A walking frame comprising:
front wheels (14) and rear wheels (16);
an upper frame part (11) and a hinged gate (111) collectively forming a closed hoop; and
wheel-holding front frame parts (13) and wheel-holding rear frame parts (15) being directly or indirectly attached to or integrated with the upper frame part (11), wherein
the hinged gate (111) is positioned at a rear end of the upper frame part (11),
a lower portion (151) of the rear wheel-holding frame parts (15) extends rearward of the rear end of the upper frame part (11) in the direction towards the rear wheels (16), and
the lower portion (151) is positioned at a height less than 35 cm above a lower surface of the wheels for a horizontal extension of at least 10 cm rear of a plumb line drawn down from the rear end of the upper frame part (11).

16. The walking frame in accordance with claim 15, wherein a vertical position of the lower portion (151) of the rear wheel-holding frame parts (15) is located less than 25 cm above the lower surface of the wheels for a horizontal extension of at least 10 cm behind a plumb line drawn down from the rear end of the upper frame part (11).

17. The walking frame in accordance with claim 15, further comprising an intermediate frame part (17) at a vertical distance from the upper frame part (11), said intermediate frame part extending between the rear wheel-holding frame parts (15) and front wheel-holding frame parts (13) on each of a left side and a right side.

18. The walking frame in accordance with claim 15, wherein the lower portion of the rear wheel-holding frame parts extend at an angle of less than 25 degrees relative to a horizontal plane.

19. The walking frame in accordance with claim 15, wherein the center of the rear wheels is located at least 20 cm rear of the plumb line drawn from the rear end of the upper frame part (11).

20. The walking frame in accordance with claim 15, wherein the rear wheel-holding frame parts have an intermediate portion adjacent the lower portion that is curved forward and located in front of the plumb line drawn from the rear end of the upper frame part (11).

21. The walking frame in accordance with claim 15, wherein the upper frame part (11) includes handles (19) at the front end.

22. The walking frame in accordance with claim 15, wherein the wheel-holding frame parts are adjustable for adjusting height of the walking frame.

23. The walking frame in accordance with claim 15, wherein the rear wheels (16) are attached to the wheel-holding frame parts via a non-rotating axis.

24. The walking frame in accordance with claim 15, wherein the upper frame part (11) includes padding (12) configured to support the forearms of the user.

25. The walking frame in accordance with claim 15, wherein the upper frame part (10) includes cushions configured to support under the armpits of the user.

26. The walking frame in accordance with claim 15, further comprising a harness (32) and at least one harness attachment (21) that is fixed to the walking frame or an integral part of the walking frame, wherein the harness (32) is configured to be attached to a user and to be attached to the at least one harness attachment (21).

27. The walking frame in accordance with claim 15, wherein at least two wheels (31) are equipped with adjustable friction.

28. The walking frame in accordance with claim 15, wherein at least two wheels (31) are arranged to be manually blocked against rotation.

29. A walking frame comprising:
front wheels (14) and rear wheels (16);
an upper frame part (11) and a hinged gate (111) collectively forming a closed hoop; and
wheel-holding front frame parts (13) and wheel-holding rear frame parts (15) being directly or indirectly attached to or integrated with the upper frame part (11), wherein
the hinged gate (111) is positioned at a rear end of the upper frame part (11),
a lower portion (151) of the rear wheel-holding frame parts (15) extends rearward of the rear end of the upper frame part (11) in the direction towards the rear wheels (16), and
in the lower portion (151), a ratio a height distance of the lower portion (151) above a lower surface of the wheels to a horizontal extension rear of a plumb line drawn down from the rear end of the upper frame part (11) is less than 3.5:1.

30. The walking frame in accordance with claim 29, wherein a vertical position of the lower portion (151) of the rear wheel-holding frame parts (15) is located less than 25 cm above the lower surface of the wheels.

31. The walking frame in accordance with claim 29, wherein the horizontal extension of the lower portion (151) rear of a plumb line drawn down from the rear end of the upper frame part (11) is approximately 10 cm.

32. The walking frame in accordance with claim 29, wherein the lower portion of the rear wheel-holding frame parts extends at an angle of less than 25 degrees relative to a horizontal plane.

33. The walking frame in accordance with claim 29, further comprising an intermediate frame part (17) at a vertical distance from the upper frame part (11), said intermediate frame part extending between the rear wheel-holding frame parts (15) and front wheel-holding frame parts (13) on each of a left side and a right side.

34. The walking frame in accordance with claim 29, wherein, in the lower portion (151), a ratio of the height distance of the lower portion (151) above a lower surface of the wheels to the horizontal extension rear of a plumb line drawn down from the rear end of the upper frame part (11) is 1:1 or less.
